(19) United States
(12) Patent Application Publication
(10) Pub. No.: US 2025/0108364 A1
(43) Pub. Date: Apr. 3, 2025

(54) CATALYST STRUCTURE

(71) Applicant: HONDA MOTOR CO., LTD., Tokyo (JP)

(72) Inventors: Akiko IWASA, Tokyo (JP); Toshiaki KIMURA, Tokyo (JP); Nobuyuki KISHI, Tokyo (JP); Kazuhisa MAEDA, Tokyo (JP); Hiromitsu TAKEDA, Tokyo (JP); Takeshi ENDO, Tokyo (JP); Genki SHIGENO, Tokyo (JP); Yuki UZAWA, Tokyo (JP)

(21) Appl. No.: 18/896,920

(22) Filed: Sep. 26, 2024

(30) Foreign Application Priority Data
Sep. 29, 2023 (JP) 2023-170782

(51) Int. Cl. B01J 35/57; B01D 53/94; B01J 23/42; F01N 3/28

(52) U.S. Cl. CPC B01J 35/57; B01D 53/94; B01J 23/42; F01N 3/2803; B01D 2255/1021; B01D 2258/01; F01N 2330/02; F01N 2330/30

(57) ABSTRACT

A catalyst device (30) includes a honeycomb core (31) in which a metal foil (40) on which a catalyst is supported is wound, in which a plurality of through holes (H) are formed in part of the metal foil (40), and in a flow direction of combustion gas (G) passing through the honeycomb core (31), a first region (A) in which the through holes (H) are not provided, a second region (B) in which the through holes (H) are provided, and a third region (C) in which the through holes (H) are not provided are lined up in this order from an upstream side thereof. A width (TA) of the first region (A) is set to be smaller than a width (TC) of the third region (C), when defining the flow direction of the combustion gas (G) as a width direction.

This application is based on and claims the benefit of priority from Japanese Patent Application No. 2023-170782, filed on 29 Sep. 2023, the content of which is incorporated herein by reference.

### BACKGROUND OF THE INVENTION

### Field of the Invention

The present invention relates to a catalyst device, and particularly relates to a catalyst device having a honeycomb core made by laminating metal foil supporting catalyst.

### Related Art

Conventionally, a catalyst device has been known which purifies the combustion gas of an internal combustion engine by letting the combustion gas of an internal combustion engine pass through a honeycomb core made by laminating metal foil supporting a catalyst such as platinum.

Japanese Patent No. 5199291 discloses a catalyst device which is configured so as to provide a plurality of through holes in metal foil in order to suppress two phenomena which tend to occur during use at high temperatures, i.e. a thermal strain phenomenon which occurs due to the temperature differences inside of the honeycomb core, and a phenomenon whereby the metal foil itself elongates due to the oxide film formed on the surface of the metal foil expanding in volume.
Patent Document 1: Japanese Patent No. 5199291

### SUMMARY OF THE INVENTION

However, the honeycomb core of Japanese Patent No. 5199291 has had a problem in that, since through holes arranged in a checker pattern are provided in the entirety of a metal foil, the pressure fluctuations inside of the catalyst device become larger upon the combustion gas flowing, and there is a possibility of brazed parts of the honeycomb core degrading due to these pressure fluctuations, and thus a countermeasure thereto is necessary.

The present invention has an object of solving the above-described problem of the conventional technology, and providing a catalyst device which can improve the durability of a honeycomb core, while maintaining the purification performance for combustion gas.

In order to achieve the object, the present invention has a first aspect in the point of a catalyst device (30) comprising a honeycomb core (31) in which a metal foil (40) on which a catalyst is supported is wound, in which a plurality of through holes (H) are formed in at least part of the metal foil (40); in a flow direction of combustion gas (G) passing through the honeycomb core (31), a first region (A) in which the through holes (H) are not provided, a second region (B) in which the through holes (H) are provided, and a third region (C) in which the through holes (H) are not provided are lined up in this order from an upstream side thereof; and a width (TA) of the first region (A) is set to be smaller than a width (TC) of the third region (C), when defining the flow direction of the combustion gas (G) as a width direction.

In addition, the present invention has a second aspect in the point of a catalyst device (30) comprising a honeycomb core (31) made by winding a metal foil (40) on which a catalyst is supported, in which a plurality of through holes (H) are formed in at least part of the metal foil (40); in a flow direction of combustion gas (G) passing through the honeycomb core (31), a first region (A) in which the through holes (H) are not provided, a second region (B) in which the through holes (H) are provided, and a third region (C) in which the through holes (H) are not provided are provided from an upstream side thereof; and a width (TA) of the first region (A) is set to be smaller than a width (TC) of the third region (C), when defining a flow direction of the combustion gas (G) as a width direction.

Furthermore, the present invention has a third aspect in the point of the metal foil (40) being configured by overlapping a flat foil (41) and a corrugated foil (42), and a first brazed part (51) which joins the flat foil (41) and the corrugated foil (42) being provided at an end on an upstream side of the honeycomb core (31).

Moreover, the present invention has a fourth aspect in the point of brazing not being conducted in the second region (B).

In addition, the present invention has a fifth aspect in the point of the catalyst device further comprising: a second brazed part (52) which joins the flat foil (41) and the corrugated foil (42) on a downstream side from the first brazed part (51); and a third brazed part (53) which joins the honeycomb core (31) and an outer casing (32) housing the honeycomb core (31), in which the second brazed part (52) and the third brazed part (53) overlap each other in a side view of the catalyst device (30).

Moreover, the present invention has a sixth aspect in the point of the second brazed part (52) and the third brazed part (53) are provided at positions adjacent to a downstream side of the catalyst device (30).

Additionally, the present invention has a seventh aspect in the point of a width (T2) of the second brazed part (52) being set to be smaller than a width (T3) of the third brazed part (53).

Furthermore, the present invention has an eighth aspect in the point of a width (TB) of the second region (B) being set to be larger than a width (TC) of the third region (C).

According to the first aspect, a catalyst device (30) comprising a honeycomb core (31) in which a metal foil (40) on which a catalyst is supported is wound, in which a plurality of through holes (H) are formed in at least part of the metal foil (40); in a flow direction of combustion gas (G) passing through the honeycomb core (31), a first region (A) in which the through holes (H) are not provided, a second region (B) in which the through holes (H) are provided, and a third region (C) in which the through holes (H) are not provided are lined up in this order from an upstream side thereof; and a width (TA) of the first region (A) is set to be smaller than a width (TC) of the third region (C), when defining the flow direction of the combustion gas (G) as a width direction. Therefore, compared to a configuration in which through holes are formed in the entirety of the metal foil, it becomes possible to disperse combustion gases in the first region on the upstream side in which through holes are not provided, and suppress the internal pressure of the catalyst device from becoming too high. It is thereby possible to enhance the durability of the honeycomb core, while maintaining the purification performance for combustion gases.

According to the second aspect, a catalyst device (30) comprising a honeycomb core (31) made by winding a metal foil (40) on which a catalyst is supported, in which a plurality of through holes (H) are formed in at least part of the metal foil (40); in a flow direction of combustion gas (G) passing through the honeycomb core (31), a first region (A) in which the through holes (H) are not provided, a second region (B) in which the through holes (H) are provided, and a third region (C) in which the through holes (H) are not provided are provided from an upstream side thereof; and a width (TA) of the first region (A) is set to be smaller than a width (TC) of the third region (C), when defining a flow direction of the combustion gas (G) as a width direction. Therefore, compared to a configuration in which through holes are formed in the entirety of the metal foil, it becomes possible to disperse combustion gases in the first region on the upstream side in which through holes are not provided, and suppress the internal pressure of the catalyst device from becoming too high. It is thereby possible to enhance the durability of the honeycomb core, while maintaining the purification performance for combustion gases.

According to the third aspect, the metal foil (40) being configured by overlapping a flat foil (41) and a corrugated foil (42), and a first brazed part (51) which joins the flat foil (41) and the corrugated foil (42) being provided at an end on an upstream side of the honeycomb core (31). Therefore, it becomes possible to raise the joint strength of the end on the upstream side which the combustion gas G first impinges, and suppress damage to the metal foil.

According to the fourth aspect, since brazing is not conducted on the second region (B), it becomes possible to avoid pressure fluctuations and stress concentration occurring by the braze entering the through holes, and thus the durability of the catalyst device can be enhanced.

According to the fifth aspect, the catalyst device further includes: a second brazed part (52) which joins the flat foil (41) and the corrugated foil (42) on a downstream side from the first brazed part (51); and a third brazed part (53) which joins the honeycomb core (31) and an outer casing (32) housing the honeycomb core (31), in which the second brazed part (52) and the third brazed part (53) overlap each other in a side view of the catalyst device (30). Therefore, the second brazed part suppresses a thermal strain phenomenon in the honeycomb core at a position adjacent to the downstream side of the catalyst device, whereby it becomes possible to suppress deformation of the outer casing and enhance the durability of the third brazed part.

According to the sixth aspect, the second brazed part (52) and the third brazed part (53) are provided at positions adjacent to a downstream side of the catalyst device (30). Therefore, by providing the second brazed part and third brazed part at positions closer to downstream which are lower temperature than the upstream side, it is possible to protect the third brazed part from heat affect, and suppress the honeycomb core from slipping out from the outer casing.

According to the seventh aspect, a width (T2) of the second brazed part (52) is set to be smaller than a width (T3) of the third brazed part (53). Therefore, even in the case of the third brazed part being influenced by the thermal strain phenomenon, the stress generated thereby will tend to disperse at the second brazed part, and thus it becomes possible to suppress the influence on the honeycomb core.

According to the eighth aspect, a width (TB) of the second region (B) is set to be larger than a width (TC) of the third region (C). Therefore, by sufficiently increasing the area of the second region in which the through holes are provided, it becomes possible to maintain the purification performance of the catalyst device.

### BRIEF DESCRIPTION OF THE DRAWINGS

FIG. 1 is a left-side view of an exhaust gas device made by applying a catalyst device according to an embodiment of the present invention;

FIG. 2 is a cross-sectional view along the line II-II in FIG. 1;

FIG. 3 is a perspective view of the catalyst device;

FIG. 4 is a front view showing the structure of a honeycomb core;

FIG. 5 is a partial enlarged perspective view showing the structure of a honeycomb core; and

FIG. 6 is a schematic cross-sectional view showing the structure of a catalyst device.

### DETAILED DESCRIPTION OF THE INVENTION

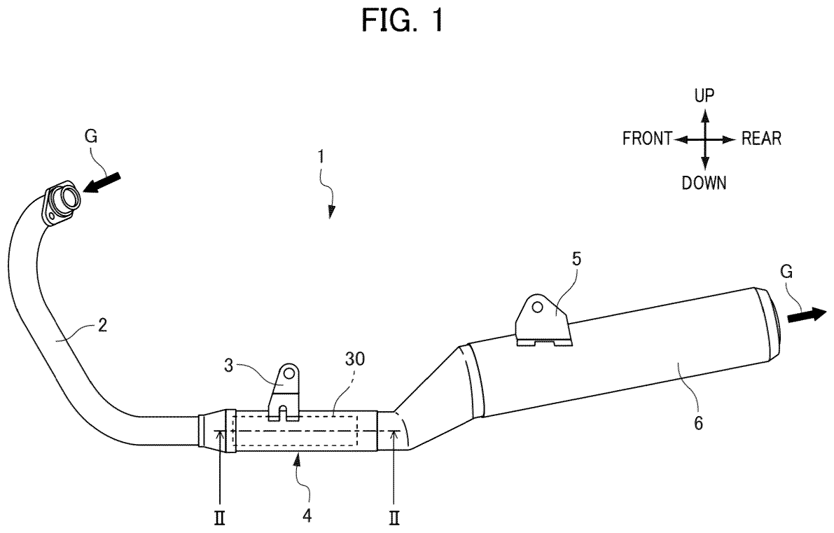

Hereinafter, preferred embodiments of the present invention will be described in detail by referencing the drawings. FIG. 1 is a left-side view of an exhaust gas device 1 configured by applying a catalyst device 30 according to an embodiment of the present invention. The directional arrow in the drawing corresponds to a direction of a vehicle such as a motorcycle to which the exhaust gas device 1 is installed.

The exhaust gas device 1 includes: an exhaust pipe 2 mounted to a cylinder head of an internal combustion engine (not shown), a catalyst storage part 4 connected to a rear part of the exhaust pipe 2, and a muffler 6 connected to a rear part of the catalyst storage part 4. Plate-like stays 3 and 5 for fixing the exhaust gas device 1 to the vehicle are provided to the catalyst storage part 4 and muffler 6. The combustion gas G of the internal combustion engine is sent through the exhaust pipe 2 to the catalyst storage part 4, and after being purified by the catalyst device 30 stored in the catalyst storage part 4, the combustion gas G is mufflered in sound by the muffler 6, and then emitted to the rear.

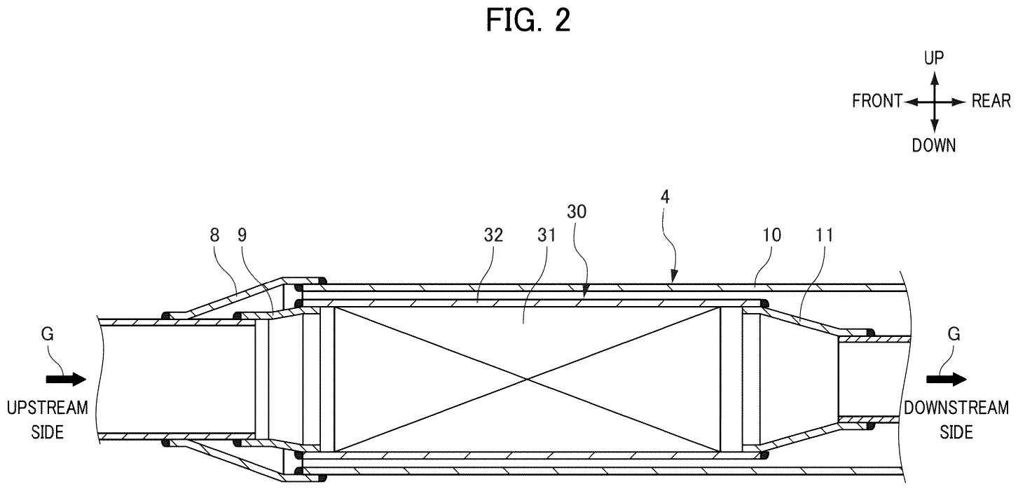

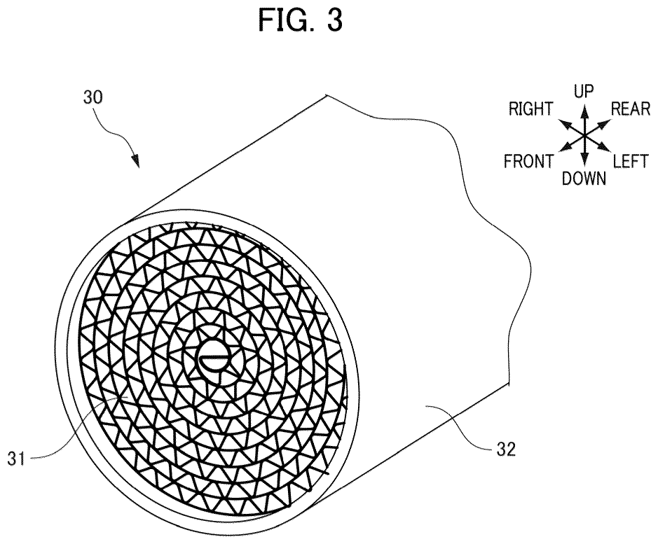

FIG. 2 is a cross-sectional view along the line II-II in FIG. 1. In addition, FIG. 3 is a perspective view of the catalyst device 30. The same reference number as described above indicates a portion which is the same or equivalent to that described above. In FIG. 2, “front” and “rear” of the directional arrows respectively correspond to the upstream side and downstream side of the combustion gas G.

The catalyst device 30 forming a substantially columnar shape is established as a configuration in which a column-shaped honeycomb core 31 is stored in a cylindrical outer casing 32. A front-side tapered tube 9 connecting to the exhaust pipe 2 is coupled to a front end of the outer casing 32. On the other hand, a rear-side tapered tube 11 connecting to a tail pipe 12 is coupled to a rear end of the outer casing 32. A radial outer side of the outer casing 32 is wrapped by a heat insulation pipe 10 constituting the catalyst storage part 4, and a front end of the heat insulation pipe 10 is coupled to the exhaust pipe 2 via the outside tapered pipe 8.

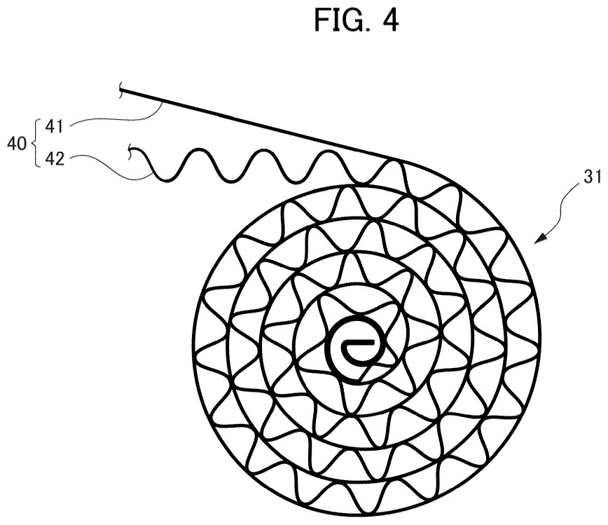

FIG. 4 is a front view showing the structure of a honeycomb core 31. The honeycomb core 31 is established as a honeycomb structure by winding around, several times, the metal foil 40 made by layering a flat foil 41 and a corrugated foil 42 on which a catalyst such as platinum is supported. The flat foil 41 and corrugated foil 42, for example, can be formed from a ferritic stainless steel having a sheet thickness of 30 to 100 μm. Manufacture of the honeycomb core 31 is performed by layering the flat foil 41 and the corrugated foil 42 on which a brazing material such as nickel brazing filler is arranged at predetermined positions to configure the metal foil 40, then the product of winding this metal foil 40 is housed in the outer casing 32, and heated in a vacuum oven to perform vacuum brazing.

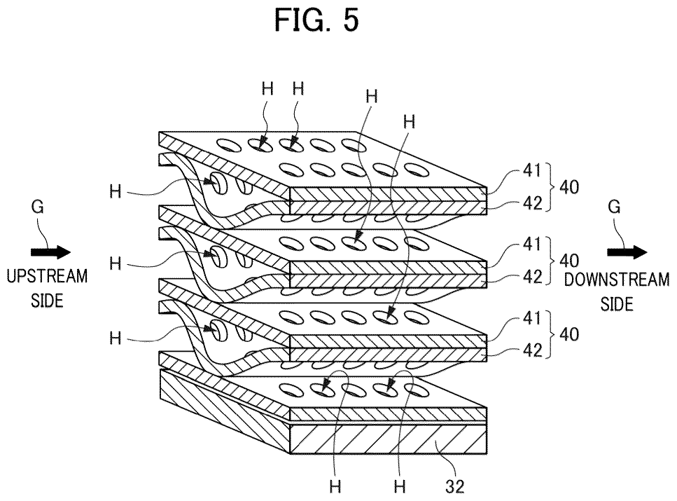

FIG. 5 is a partial enlarged perspective view showing the structure of the honeycomb core 31. The same reference numbers as described above indicate the same or equivalent portions. The flat foil 41 and the corrugated foil 42 are joined by brazing to each other at the apexes of peaks and valleys of the corrugated foil 42. A plurality of through holes H are formed in each of the flat foil 41 and corrugated foil 42. These through holes H are provided in order to prevent the phenomenon of thermal strain occurring by the temperature differences inside of the honeycomb core 31, and the phenomenon of the metal foil 40 itself elongating by the oxide film formed on the surface of the metal foil 40 expanding in volume.

However, for example, when providing through holes H in the entirety of the metal foil 40, the pressure fluctuations inside of the catalyst device 30 become large upon the combustion gas G flowing therein, and there is a possibility of the brazed portions of the honeycomb core 31 degrading due to these pressure fluctuations, and thus there has been a problem in that countermeasures thereto are necessary. Addressing this problem, the present invention intentionally provides a region in which through holes H are not provided, thereby enabling an improve in the durability of the honeycomb core 31, while maintaining the purification performance for combustion gas G.

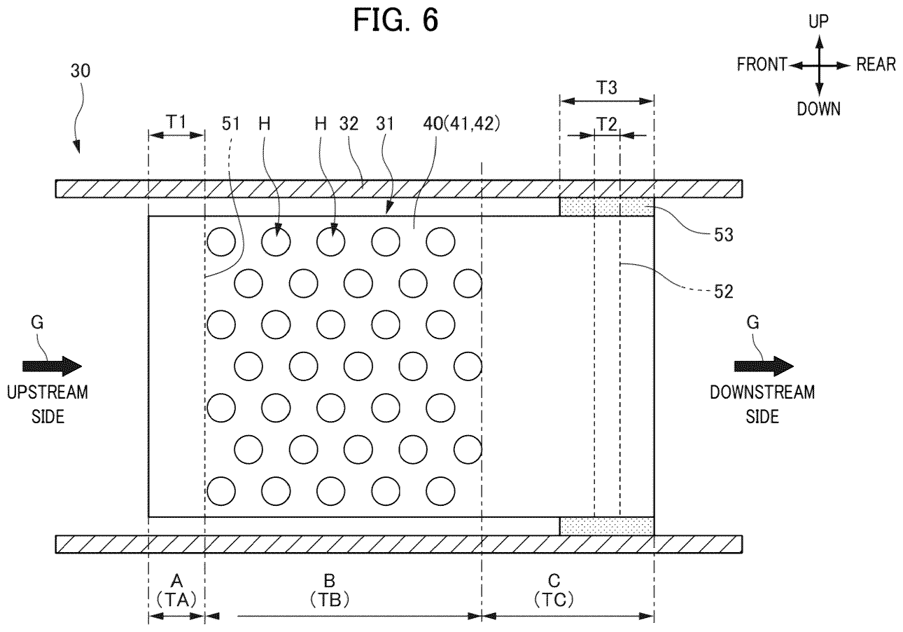

FIG. 6 is a schematic cross-sectional view showing the structure of the catalyst device 30. In the honeycomb core 31 according to the present embodiment, a first region A in which through holes H are not provided, a second region B in which through holes H are provided, and a third region C in which through holes H are not provided are lined up in order from the upstream side of the combustion gas G. Then, when defining the flow direction of the combustion gas G as a width direction, there is a feature in the point of the width TA of the first region A being set to be smaller than the width TC of the third region C.

Compared to a configuration in which the through holes H are formed in the entirety of the metal foil 40, it thereby becomes possible to disperse the combustion gas G by the first region A on the upstream side in which the through holes H are not provided, and suppress the internal pressure of the catalyst device 30 from becoming too high. It is thereby possible to improve the durability of the honeycomb core 31, while maintaining the purification performance of the combustion gas G.

The through holes H, for example, can establish a configuration staggering the arrangement of circular holes of φ2.2 in 33 rows. It should be noted that the through holes H may be reduced in diameter to increase the number of holes, or the shape may be made non-circular such as ellipse. In the present embodiment, as a result of considering the balance between purification performance and durability, the width TB of the second region B is set to about ½ of the total width.

In addition, the present invention has a feature in the point of the first brazed part 51 joining the flat foil 41 and corrugated foil 42 being provided at an end on the upstream side of the honeycomb core 31. It thereby becomes possible to raise the joint strength of the end on the upstream side which the combustion gas G first impinges, and suppress damage to the metal foil.

In addition, in the present embodiment, brazing is not conducted on the second region B in which the through holes H are provided. It thereby becomes possible to avoid pressure fluctuations and stress concentration occurring by braze entering the through holes H, and thus it is possible to improve the durability of the catalyst device 30.

The catalyst device 30 includes a second brazed part 52 which joins the flat foil 41 and corrugated foil 42 at positions adjacent to the downstream side. Furthermore, the catalyst device 30 includes a third brazed part 53 joining the honeycomb core 31 and the outer casing 32 which accommodates this honeycomb core 31. Then, the present embodiment has a feature in the point of the second brazed part 52 and third brazed part 53 overlapping each other in a side view of the catalyst device 30. The second brazed part 52 suppresses a thermal strain phenomenon of the honeycomb core 31 at a position adjacent to the downstream side of the catalyst device 30, whereby it becomes possible to suppress deformation of the outer casing 32, which improves the durability of the third brazed part 53.

The second brazed part 52 and third brazed part 53 are arranged at positions adjacent to the downstream side of the catalyst device 30. It is thereby possible to prevent excessive temperature rise of the second brazed part 52 and third brazed part 53, and it is particularly possible to suppress the second brazed part 52 from deteriorating, and the honeycomb core 31 slipping out from the outer casing 32 of the catalyst device 30.

In addition, the width T2 of the second brazed part 52 is set to be smaller than the width T3 of the third brazed part 53. Even in the case of the third brazed part 53 being influenced by the thermal strain phenomenon, the stress generated thereby will tend to disperse at the second brazed part 52, and thus it is possible to protect the honeycomb core 31. Furthermore, since the width TB of the second region B is set to be larger than the width TC of the third region C, by sufficiently increasing the area of the second region B in which the through holes H are provided, it becomes possible to maintain the purification performance of the catalyst device 30.

In the embodiment described above, the width TA of the first region A and the width T1 of the first brazed part 51 are set to be equal; however, both widths may be set to be different.

The form of the vehicle to which the exhaust gas device is installed, the shape and structure of the exhaust gas device, shape and arrangement of the catalyst device, materials of the flat foil and the corrugated foil constituting the metal foil of the honeycomb core, widths of the first region, the second region and the third region, widths and arrangements of the first brazed part, the second brazed part and the third brazed part, shape and size of the through holes, number of the through holes, etc. are not limited to the above-described embodiment, and various modifications thereto are possible. For example, the catalyst device is not limited to being a column shape, and may be established as a shape having an elliptic cross section, or the like. In addition, the above-described embodiment shows a configuration lining up in order of the first region in which the through holes are not provided, the second region in which the through holes are provided, and the third region in which the through holes are not provided, in order from the upstream side; however, a plurality of regions in which the through holes are not provided and regions in which the through holes are provided may be sandwiched between the second region and the third region, for example. The catalyst device according to the present invention is not limited to a motorcycle, and it is also possible to apply to vehicles which are three-wheeled or four-wheeled, etc. and to the exhaust gas devices of various devices with an internal combustion engine as the power source.

### EXPLANATION OF REFERENCE NUMERALS

1 exhaust gas device
30 catalyst device
31 honeycomb core
32 outer casing
40 metal foil
41 flat foil
42 corrugated foil
51 first brazed part
52 second brazed part
53 third brazed part
A first region
B second region
C third region
TA width of first region
TB width of second region
TC width of third region
T1 width of first brazed part
T2 width of second brazed part
T3 width of third brazed part
H through hole
G combustion gas

What is claimed is:

1. A catalyst device (30) comprising a honeycomb core (31) in which a metal foil (40) on which a catalyst is supported is wound,
wherein a plurality of through holes (H) are formed in at least part of the metal foil (40),
in a flow direction of combustion gas (G) passing through the honeycomb core (31), a first region (A) in which the through holes (H) are not provided, a second region (B) in which the through holes (H) are provided, and a third region (C) in which the through holes (H) are not provided are lined up in this order from an upstream side thereof, and
a width (TA) of the first region (A) is set to be smaller than a width (TC) of the third region (C), when defining the flow direction of the combustion gas (G) as a width direction.

2. A catalyst device (30) comprising a honeycomb core (31) made by winding a metal foil (40) on which a catalyst is supported,
wherein a plurality of through holes (H) are formed in at least part of the metal foil (40),
in a flow direction of combustion gas (G) passing through the honeycomb core (31), a first region (A) in which the through holes (H) are not provided, a second region (B) in which the through holes (H) are provided, and a third region (C) in which the through holes (H) are not provided are provided from an upstream side thereof, and
a width (TA) of the first region (A) is set to be smaller than a width (TC) of the third region (C), when defining a flow direction of the combustion gas (G) as a width direction.

3. The catalyst device according to claim 1, wherein the metal foil (40) is configured by overlapping a flat foil (41) and a corrugated foil (42), and
wherein a first brazed part (51) which joins the flat foil (41) and the corrugated foil (42) is provided at an end on an upstream side of the honeycomb core (31).

4. The catalyst device according to claim 2, wherein the metal foil (40) is configured by overlapping a flat foil (41) and a corrugated foil (42), and
wherein a first brazed part (51) which joins the flat foil (41) and the corrugated foil (42) is provided at an end on an upstream side of the honeycomb core (31).

5. The catalyst device according to claim 1, wherein brazing is not conducted in the second region (B).

6. The catalyst device according to claim 2, wherein brazing is not conducted in the second region (B).

7. The catalyst device according to claim 3, further comprising:
a second brazed part (52) which joins the flat foil (41) and the corrugated foil (42) on a downstream side from the first brazed part (51); and
a third brazed part (53) which joins the honeycomb core (31) and an outer casing (32) housing the honeycomb core (31),
wherein the second brazed part (52) and the third brazed part (53) overlap each other in a side view of the catalyst device (30).

8. The catalyst device according to claim 4, further comprising:
a second brazed part (52) which joins the flat foil (41) and the corrugated foil (42) on a downstream side from the first brazed part (51); and
a third brazed part (53) which joins the honeycomb core (31) and an outer casing (32) housing the honeycomb core (31),
wherein the second brazed part (52) and the third brazed part (53) overlap each other in a side view of the catalyst device (30).

9. The catalyst device according to claim 7, wherein the second brazed part (52) and the third brazed part (53) are provided at positions adjacent to a downstream side of the catalyst device (30).

10. The catalyst device according to claim 8, wherein the second brazed part (52) and the third brazed part (53) are provided at positions adjacent to a downstream side of the catalyst device (30).

11. The catalyst device according to claim 7, wherein a width (T2) of the second brazed part (52) is set to be smaller than a width (T3) of the third brazed part (53).

12. The catalyst device according to claim 8, wherein a width (T2) of the second brazed part (52) is set to be smaller than a width (T3) of the third brazed part (53).

13. The catalyst device according to claim 1, wherein a width (TB) of the second region (B) is set to be larger than a width (TC) of the third region (C).

14. The catalyst device according to claim 2, wherein a width (TB) of the second region (B) is set to be larger than a width (TC) of the third region (C).
